(19) United States
(12) Patent Application Publication
(10) Pub. No.: US 2007/0176409 A1
(43) Pub. Date: Aug. 2, 2007

(54) Book publishing kit and method

(76) Inventor: Joseph Moses, Minneapolis, MN (US)

Correspondence Address: Mark A. Litman & Associates, P.A.;Yorke Business Center, Suite 205, 3209 West 76th St., Edina, MN, 55435, US

(21) Appl. No.: 11/343,118

(22) Filed: Jan. 30, 2006

(51) Int. Cl. B42D 1/00

(52) U.S. Cl. 281/21.1

(57) ABSTRACT

A kit is described for manufacturing books along with a method of manufacturing a book. Two distinct stiffening faces are provided against an adhesive sheet surface so that a first side of each the two stiffening faces is secured to the adhesive sheet surface with borders of the sheet surface extend beyond all edges of the two faces. A distinct stiffening spine is also placed on the adhesive sheet surface between adjacent edges of the of the two faces so that the spine is secured to the adhesive sheet surface with borders of the adhesive sheet surface at a top and a bottom of the spine extend beyond the top and bottom of the spine. The borders are folded at the top and bottom of the spine and around all edges of the faces to secure the cover to the faces and the spine, with cover material forming a border around three edges of each face. Pages are secured together, the pages having surface dimensions smaller than surface dimensions of the faces and the secured pages are further secured between the faces.

### BACKGROUND OF THE INVENTION

1. Field of the Invention

The present invention relates to the field of book-making, publishing and kits for enabling book-making. The field particularly includes unique book manufacturing by individuals, including children.

2. Background of the Art

The original manufacture of bound books was as much art and craftsmanship as technology. Even after handwriting of text was replaced by mechanical printing assemblies, pages and covers were manually bound and secured between hard covers, such as finished leather, to assure permanence to the books. Books have been hand stitched, hand glued, mechanically stitched and glued by automation for many years. The casual user does not fully appreciate the effort undertaken in the publication of books, assuming that it is just another available manufacturing process.

Some effort has been made in the past to bring book-making and publication to a simplified level that can be practiced (for individual books) by individuals, including children to assist their appreciation of the process.

U.S. Pat. No. 6,394,729 (Welch) describes unibody binder constructions and the process of making same. The binder is composed of two plastic sheets comprising such material as polyvinyl chloride, polyolefin, polypropylene, polyvinyl acetate or other similar plastics. An uncompromised single piece of board or similar rigid material, such as chipboard, microflute board, corrugated board, fiberboard, etc., or a synthetic substrate, is then coated with a glue such as a resin glue, a U.V. adhesive, etc., on both sides and sandwiched between the plastic sheets. This sandwich is then formed into the unibody construction by welding the entire outer perimeter. At the time of welding, the air between the plastic sheets and the board is pressed or vacuumed out. To create the hinges on the binder, the unibody construction is then hydraulically creased to the extent necessary by using three moving blades to provide living hinges. Many different spine configurations may be achieved depending on the number of creases desired for flexibility. Various capacities of ring metals may be accommodated by increasing or decreasing the number of creases or distances therebetween. Also, various round or flat back profiles can be formed after the flat board has been sealed into a sandwich between two plastic sheets that have been welded together. A clear plastic sheet secured to the bottom and side edges of the outer plastic sheet to provide a pocket for visible inserts and plastic sheets can be secured to the inner plastic sheet to provide inner pockets for inserts.

U.S. Pat. No. 5,397,156 (Schach et al.) describes a kit that enhances the marketability of personalized books, such as paperback romance novels. The kit includes a simulated book constructed of a book cover and foam core adhesively secured to it, and a questionnaire for insertion of personalized information. The questionnaire and a reply addressed envelope are provided between the cover and the foam core, and the simulated book is shrink wrapped in transparent plastic. The questionnaire is on difficult to accurately photocopy paper, such as colored paper and/or ink with a distinctive watermark or printed background design, and/or a serial number (e.g. in bar code format). Instructions on what to do with the questionnaire are provided on the rear face of the simulated book cover. The kit is sold for a price that includes printing and delivery of the basic personalized book, and when a completed original questionnaire is received the personalized book is printed utilizing as part of the text of the book the personalized information on the questionnaire, and is delivered to the purchaser.

U.S. Pat. No. 6,126,202 (Scocca) describes a book publishing kit for children, the kit including two templates and a number of sheets. The sheets include a cover on which a cover template is placed with a cut out preferably rectangular area in which a drawing can be made. Sheets are provided for internal book pages and another template is placed on each of these pages with a cut out preferably rectangular opening of a different sizing and centering with respect to the page than that of the cover sheet for illustration purposes. The bottom of each page is reserved for printing text of up to fifteen words in length. Separate sheets are provided with boxes in which text for the pages can be written and the page number indicated within a smaller box of each respective text box. The sheets are sent to the publisher in a self addressed envelope with the order form filled out indicating whether the child's spelling should be corrected. The kit includes washable markers for the illustrations.

U.S. Pat. No. 6,435,559 (Duke) describes an adjustable book jacket and book cover combination for a book comprising a book jacket for covering said book cover wherein the book jacket contains printed indicia of the subject matter of said book, and the jacket indicia, by reason of graphics, color or text is susceptible to easy perception and identification when said book containing said book jacket is arranged in partial overlapping sequence from east to west. The book cover similarly contains printed indicia of the subject matter of the book and said cover indicia by reason of graphics, color or text being susceptible is also easy perceived and identified when said book containing said book cover is arranged in partial overlapping sequence from north to south.

U.S. Pat. No. 3,964,770 (Abildgaard et al.) describes a hard case for a book is provided with a pad which is attached to the spine edge of an uncased book by pressure- sensitive adhesive. This pad comprises a strip of foam of a material such as polyurethane of a length substantially the same as that of the cover boards for the case and a width slightly less than the gap between adjacent boards which is fastened to the cover material by the same adhesive which causes the cover material to adhere to the boards. In order to provide a non-porous surface for the foam, the latter may be covered by a layer of vinyl, the latter being of the same length and width as the pad and stuck thereto by a suitable adhesive. A layer of pressure-sensitive adhesive is applied to the vinyl cover and a protective release paper covers the pressure-sensitive adhesive. The adhesive and release paper are spaced inward at top and bottom from the top and bottom edges of the boards. In production of the case the top and bottom of the cover material are turned in to cover the edges of the boards and such turn-ins also cover the ends of the pad but not the release paper. In use, the release paper is stripped off exposing the pressure-sensitive material. The spine edge of the uncased book is forced against the pressure-sensitive material. End leaves of the book are caused to adhere to the boards.

Published U.S. Patent Application 2004/0119278 describes a Kit and Method for Producing a Perfect Bound Book which comprises a rigid book-like cover and a supply of sheets of paper sized to fit in the cover and adapted for use in the kit. An opening is provided on the front cover for insertion of art work, including photographs.

Published U.S. Patent Application No. 2005/0141987 (Steele) describes a kit for manufacturing a stitch-bound printed book comprises a book cover (10), a collection of pre-perforated sheets (15) that can be printed to make up a printed bookblock (18), and endpapers (20a,20b) for assembling the printed bookblock in the cover. The pre- perforated loose sheets (15) have along one edge that corresponds to the book's spine a series of binding perforations (16). The pre-perforated loose sheets (15) are printable on one or both sides in an A4 printer to constitute printed pages of the book. A bookblock (18) is formed by reconstituting the printed pre-perforated pages as a collection with their perforations (16) aligned and by sewing through the perforations (16). This involves stitch-binding of individual sheets (15) instead of the usual stitch-binding of folded sheets, which makes it feasible to print the prepared collection of pre-perforated sheets using desktop publishing equipment. The kit lends itself to using adhesive contact paper for the endpapers (20a,20b) in place of the application of glue, making binding practical and convenient.

### SUMMARY OF THE INVENTION

A self-publishing book kit and method of using the kit enables a system than provides detailed instructions and appreciation of the art of book binding and book making. The kit includes hard backing supports for the faces of the book, a hard spine for support of the book, alignment or registration markers to assist in placement of at least the spine, an adhesively attachable cover for the book and other optional features.

### BRIEF DESCRIPTION OF THE FIGURES

FIG. 1 shows the adhesive cover that is used for the kit, with registration markers on the adhesive surface or inside surface of the cover.

FIG. 2 shows a hard back support for the book.

FIG. 3 shows the hard spine for the book.

### DETAILED DESCRIPTION OF THE INVENTION

The book binding kit of the presently described technology is intended to provide a learning and appreciation system for the art of book making, as well as providing a kit that can be used to produced relatively unique books easily by users who cover a wide range of ages. At an absolute minimum, the kit contains two rigid and separate book facings, a book spine, and a preformed, printable adhesive book cover that is sized to exactly accommodate the facings and the spine. The protective release liner of the book cover or the interior surface of the cover itself has registration marks thereon to at least identify the specific placement of the spine against the adhesive face of the book cover. Registration marks may also be provided for the faces of the book. The registration marks need be in a useful position for aligning elements to be secured, such as the spine or faces. To that end, the registration marks may be on the adhesive face itself or on the liner covering the adhesive layer.

The book cover may consist of two boards, an inlay, and covering material. The case is made separately from the text block and is later attached to it in a step called casing-in. (LBI Standard, Glossary, pg. 13).

Case binding is a method of binding in which the book case (cover) is made separately from the textblock and later attached to it. (As distinguished from leather bindings where the cover is assembled on the book.) The textblock is attached to its case by means of super hinge endsheets, and an adhesive.

Casing is the process of applying adhesive to the outermost endpapers of a text block and fitting the text block into its case. (LBI Standard, Glossary, pg. 14). Based on the above information, might we say that the case is made of a pressure sensitive adhesive sheet affixed with two boards and a spine. The terms “faces” as used herein are the outer individual panels that are used to form the front and rear cover element on a book. These are typically the cover elements over which a jacket may be secured and protects the pages from incidental punctures, soiling and abrasion.

The book faces are of a relatively rigid or semi-rigid construction and are typically rectangular or square, depending upon the precise shape desired on the case. The book faces may be equal in dimensions or different, again depending upon the book shape and design intended. In most cases the book faces are of equal dimensions and are rectangular. The composition of the case is important to the degree that it provides the desired structural and physical properties for the book. The covers may be common book facing materials such as cardboard, dense fiber sheet, polymeric sheet, composite sheet, and be reinforced or non-reinforced. AS the book faces are to be adhesively secured to the adhesive cover, it is important that they face, at least the interior surface of the face, be able to have the adhesive secure to its surface with sufficient strength to be able to hold the cover to the face securely.

Dimensions of the faces may range from as little as 5 cm to as large as 0.5 meters, with a typical range being on the order of at least 8 cm an edge up to 40 cm on an edge.

The Spine

The composition of the spine may be the same as the composition of the book faces described above. Its physical function is similar to that of the book faces, although in a different location, being positioned with its major surface perpendicular to the pages in the book, as opposed to parallel relationship of the faces to the pages in the book. The spine, as noted, may be of the same thickness or thinner than the faces, or even a little thicker or made of a stronger material, if additional strength is desired in the spine. The spine may, by way of non-limiting example, be at least 80%, at least 90% and 100% (or even slightly more) than the height of the intended book. It may be as narrow as 0.2 cm and as wide as 5 cm, depending upon the number and thickness of pages and the thickness of the final book intended. A preferred range is between 0.4 cm and 3 cm because of an intended commercial market for the product. By way of background and not limitation, a typical definition for a “book” is an article that consists of two or more sheets secured together either: (a) only at their margins; or (b) only at a restricted field within the margins; or (c) only at their margins and at a restricted field within the margins. When a margin of one sheet is attached to a margin of another sheet to obtain in effect a single sheet or greater area, the resulting article is still regarded as a sheet(*) rather than a book. A folded sheet is not considered to be a book.

The Pressure-sensitive Adhesive Case

The adhesive case is a sheet of material, preferably printable or writeable, that is covered at least in strategic regions on one surface thereof with a pressure-sensitive adhesive. By printable, standard commercial or consumer printing processes such as ink-jet, bubble jet, laser printing, dry electrophotography, liquid electrophotography, hand stamping, roller or gravure printing and the like, are possible. The adhesive may be as weak as Post-It® brand repositionable adhesives, or may be more aggressive and more permanently aggressive acrylate pressure-sensitive adhesives. The adhesive may be provided as a continuous coating or as a pattern or cover the entire adhesive back surface so that the cover will strongly adhere to the faces, and if separate adhesive is not provided on the spine, also to the spine so that the book does not readily fall apart.

The use of adhesive over the entire back surface will strongly adhere the faces to the cover and provide a secure hold to both the inside edge and outside total surface of the covers. Construction of the book may proceed by the spine and the faces being placed on the adhesive cover. This is done before complete assembly of the book. There may be, and likely will be exposed adhesive on the adhesive surface between the spine and the faces and about the edge of the faces. The cover sheet with the adhesive thereon should or must be of a size that has dimensions greater than the total of the dimensions of the spine, the faces, and spacing between the spine and the faces to enable the adhesive cover sheet to fold over the exterior edges of the spine and the faces. If there were no additional length or width to the adhesive cover sheet with respect to the dimensions of the spine and the faces, the edges of the cover sheet and the edges of the spine and faces would be of the same dimensions and the edges of the cover sheet would be more readily lifted from the faces.

The corners of the covers may be full right angles of the rectangle, or sections at the corners (e.g., squares) may be cut from the cover material so that when the side edge and then the top edge (or vise-versa) of the cover is folded and adhesively secured to the faces and the spine, there need not be a significant overlap of cover material at the corner, but rather a sized absence of material overlays the folded edge from the adjacent side.

The portion of the adhesive cover sheet that would form the front of the face or case may have a pocket or hole built therein to retain art work. The adhesive face or adhesive portions of the cover would secure the window or pocket onto the front of the book. It is also to be noted that there is in fact a benefit of having the exposed adhesive between the cover board and the spine. The exposed adhesive holds the page assembly in place for accurately aligning the page assembly with the cover.

A review of the figures would assist in appreciating the practice of the technology.

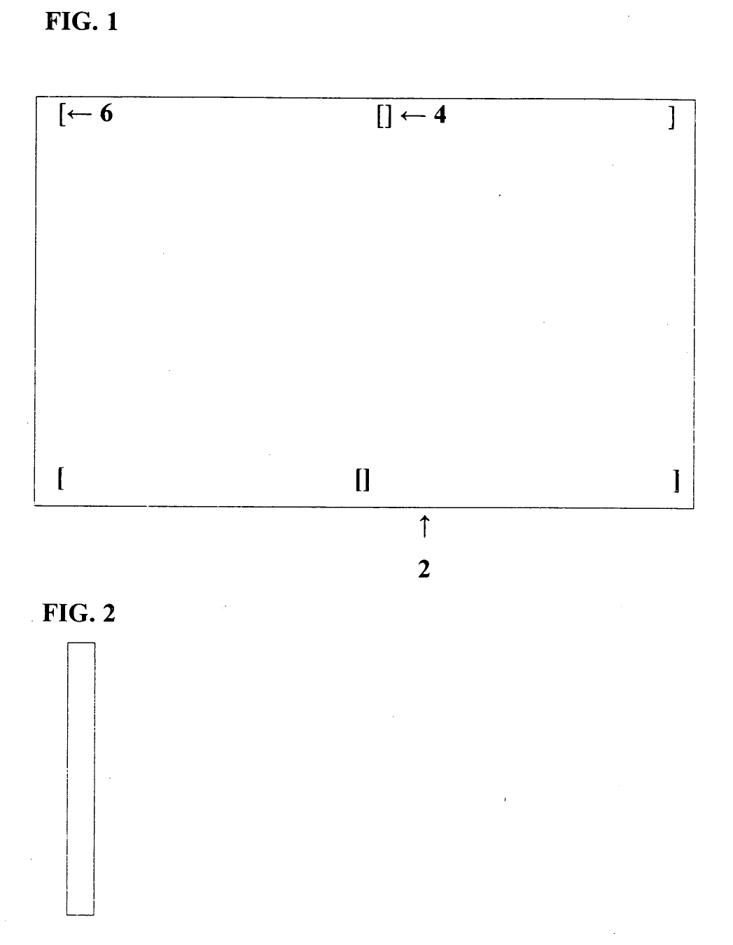

FIG. 1 shows the adhesive cover 2 that is used for the kit, with registration markers on the adhesive face of the cover for the spine 4 and for the corners of the faces 6.

FIG. 2 shows the hard spine for the book.

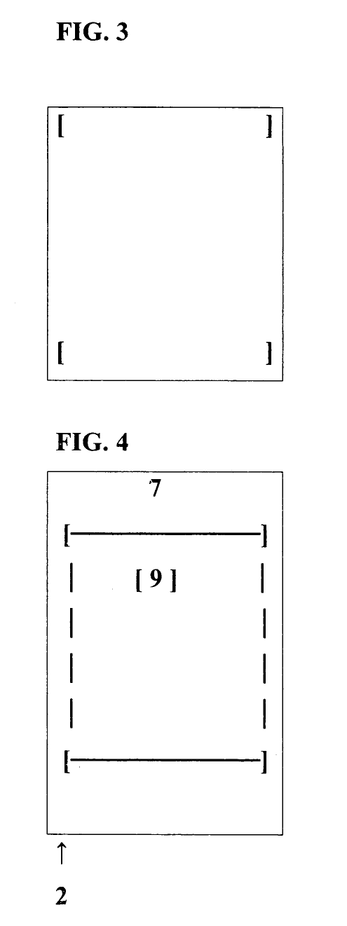

FIG. 3 shows a hard back support for the book with indications of approximate overlap of the edges of the cover (not shown) onto the faces.

FIG. 4 shows a cover sheet 2 with an area 7 surrounding the edges of the cover sheet, with adhesive thereon. A window or pocket 9 is shown. The cover sheet 2 would be folded over the faces (once they and the spine have been properly placed and adhesively secured to adhesive containing areas, and the cover folded over the edges of the faces and spine to form the hard cover for the book.

Pages or paper on which alphanumerics and/or images can be provided can also be provided with the kit. The paper should also be sized so that the paper will fit between the covers of the book, rather than extending beyond the edges of the covers. The pages are to be secured together, as by binding, ring loops, adhesive binding, stitching, stapling, clipping, prong fasteners, and other mechanical or quasi-mechanical (adhesive) securing that can be practiced. The bound pages are then fixed to the inner surfaces of the covers, or a reinforced section of the cover may be provided (as with fabric along the surface where the spine would be placed and extending beyond the edges of the spine to allow for mechanical fastening.

What is claimed:

1. A method of providing a book comprising:
placing two distinct stiffening faces against an adhesive sheet surface so that a first side of each the two stiffening faces is secured to the adhesive sheet surface with borders of the sheet surface extend beyond all edges of the two faces;
placing a distinct stiffening spine on the adhesive sheet surface between adjacent edges of the of the two faces so that the spine is secured to the adhesive sheet surface with borders of the adhesive sheet surface at a top and a bottom of the spine extend beyond the top and bottom of the spine;
folding the borders at the top and bottom of the spine and around all edges of the faces to secure the cover to the faces and the spine, with cover material forming a border around three edges of each face;
securing pages together, the pages having surface dimensions smaller than surface dimensions of the faces; and
securing the secured pages between the faces.

2. The method of claim 1 wherein registration marks are present on the adhesive surface of the cover and the spine is positioned at an orientation specific to those registration marks.

3. The method of claim 2 wherein second registration marks are present on the adhesive surface of the cover and a face is positioned at an orientation specific to those registration marks.

4. The method of claim 1 wherein secured pages are secured between the faces by adhesive.

5. The method of claim 4 wherein the secured papers have been secured by staples.

6. A kit for the manufacture of individual books comprising two distinct stiffening faces, a stiff spine element, and an adhesively faced cover sheet,
the two distinct stiffening faces each having a height and a width,
the stiff spine element having a height and a width,
the adhesively faced cover sheet having a height and a width, wherein the sum of the widths of the two stiffening faces and the width of the spine is less than the width of the adhesively faced cover sheet, and the individual heights of the two stiffening faces and the height of the spine are each less than the height of the adhesively faced cover sheet, and
wherein an adhesive face on the adhesively faced cover sheet has at least registration marks thereon for positioning of the spine element against the adhesive face.

7. The kit of claim 6 wherein the adhesive face has registration marks for the positioning of the two distinct stiffening faces against the adhesive face.
